(19) United States
(12) Patent Application Publication
(10) Pub. No.: US 2008/0162121 A1
(43) Pub. Date: Jul. 3, 2008

(54) METHOD, MEDIUM, AND APPARATUS TO CLASSIFY FOR AUDIO SIGNAL, AND METHOD, MEDIUM AND APPARATUS TO ENCODE AND/OR DECODE FOR AUDIO SIGNAL USING THE SAME

(75) Inventors: Chang-yong Son, Gunpo-si (KR); Eun-mi Oh, Seongnam-si (KR); Ki-hyun Choo, Seoul (KR); Jung-hoe Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/964,963

(22) Filed: Dec. 27, 2007

(30) Foreign Application Priority Data
Dec. 28, 2006 (KR) 2006-136823

(51) Int. Cl. G10L 19/00

(52) U.S. Cl. 704/201; 704/E19.041

(57) ABSTRACT

Provided are a classifying method and apparatus for an audio signal, and an encoding/decoding method and apparatus for an audio signal using the classifying method and apparatus. In the classification method, an audio signal is classified by adaptively adjusting a classification threshold for a frame of the audio signal that is to be classified according to a long-term feature of the audio signal, thereby improving a hit rate of signal classification, suppressing frequent mode switching per frame, improving noise tolerance, and providing smooth reconstruction of the audio signal.

### CROSS-REFERENCE TO RELATED APPLICATIONS

This application claims priority from Korean Patent Application No. 10-2007-00136823, filed on Dec. 28, 2006, in the Korean Intellectual Property Office, the disclosure of which is incorporated herein in its entirety by reference.

### BACKGROUND OF THE INVENTION

1. Field of the Invention

The present general invention concept relates a method and apparatus to classify for an audio signal and a method and apparatus to encode and/or decode for an audio signal using the method and apparatus to classify, and more particularly, to a system that classifies audio signals into music signals and speech signals, an encoding apparatus that encodes an audio signal according to whether it is a music signal or a speech signal, and an audio signal classifying method and apparatus which can be applied to Universal Codec and the like.

2. Description of the Related Art

Audio signals can be classified into various types, such as speech signals, music signals, or mixtures of speech signals and music signals, according to their characteristics, and different coding methods or compression methods are applied to these types. Compression methods for audio signals can be roughly divided into an audio codec and a speech codec. The audio codec, such as Advanced Audio Coding Plus (aacPlus), is intended to compress music signals. The audio codec compresses a music signal in a frequency domain using a psychoacoustic model. When a speech signal is compressed using the audio codec, sound quality degradation is worse than that caused by compression of an audio signal using the speech codec and becomes more serious when the speech signal includes an attack signal. The speech codec, such as Adaptive Multi Rate-WideBand (AMR-WB), is intended to compress speech signals. The speech codec compresses an audio signal in a time domain using an utterance model. When an audio signal is compressed using the speech codec, sound quality degradation is worse than that caused by compression of a speech signal using the audio codec. Accordingly, it is important to classify an audio signal into an exact type.

U.S. Pat. No. 6,134,518 discloses a method for coding a digital audio signal using a CELP coder and a transform coder. Referring to FIG. 1, a classifier 20 measures the autocorrelation of an input audio signal 10 to select one of a CELP coder 30 and a transform coder 40 based on the measurement. The input audio signal 10 is coded by whichever one of the CELP coder 30 and the transform coder 40 are selected, by switching of a switch 50. The US patent discloses the classifier 20 that calculates a probability that a current audio signal is a speech signal or a music signal using autocorrelation in the time domain.

However, because of weak noise tolerance, the disclosed technique has a low hit rate of signal classification under noisy conditions. Moreover, frequent oscillation of an audio signal mode in frame units cannot provide a smooth reconstructed audio signal.

### SUMMARY OF THE INVENTION

The present invention provides a classifying method and apparatus for an audio signal, in which a classification threshold for a current frame that is to be classified is adaptively adjusted according to a long-term feature of the audio signal in order to classify the current frame, thereby improving the hit rate of signal classification, suppressing frequent oscillation of a mode in frame units, improving noise tolerance, and improving smoothness of a reconstructed audio signal; and an encoding/decoding method and apparatus for an audio signal using the classifying method and apparatus.

According to an aspect of the present invention, there is provided a method of classifying an audio signal, comprising: (a) analyzing the audio signal in units of frames, and generating a short-term feature and a long-term feature from the result of analyzing; (b) adaptively adjusting a classification threshold for a current frame that is to be classified, according to the generated long-term feature; and (c) classifying the current frame using the adjusted classification threshold.

According to another aspect of the present invention, there is provided an apparatus for classifying an audio signal, comprising: a short-term feature generation unit to analyze the audio signal in units of frames and generating a short-term feature; a long-term feature generation unit to generate a long-term feature using the short-term feature; a classification threshold adjustment unit to adaptively adjust a classification threshold for a current frame that is to be classified, by using the generated long-term feature; and a classification unit to classify the current frame using the adjusted classification threshold.

According to another aspect of the present invention, there is provided an apparatus for encoding an audio signal, comprising: a short-term feature generation unit to analyze an audio signal in units of frames and generating a short-term feature; a long-term feature generation unit to generate a long-term feature using the short-term feature; a classification threshold adjustment unit to adaptively adjust a classification threshold for a current frame that is to be classified, using the generated long-term feature; a classification unit to classify the current frame using the adaptively adjusted classification threshold; an encoding unit to perform the classified audio signal in units of frames; and a multiplexer to perform bitstream processing on the encoded signal so as to generate a bitstream.

According to another aspect of the present invention, there is provided a method of decoding an audio signal, comprising: receiving a bitstream including classification information regarding each of frames of an audio signal, where the classification information is adaptively determined using a long-term feature of the audio signal; determining a decoding mode for the audio signal based on the classification information; and decoding the received bitstream according to the determined decoding mode.

According to another aspect of the present invention, there is provided an apparatus for decoding an audio signal, comprising: a receipt unit to receive a bitstream including classification information for each of frames of an audio signal, where the classification information is adaptively determined using a long-term feature of the audio signal; a decoding mode determination unit to determine a decoding mode for the received bitstream according to the classification information; and a decoding unit to decode the received bitstream according to the determined decoding mode.

According to another aspect of the present invention, there is provided a computer readable medium having recorded thereon a computer program for executing the method of classifying an audio signal.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram of a conventional audio signal encoder;

FIG. 2 is a block diagram of an apparatus to encode for an audio signal according to an embodiment of the present general inventive concept;

FIG. 3 is a block diagram of an apparatus to classify for an audio signal according to an embodiment of the present general inventive concept;

FIG. 4 is a detailed block diagram of a short-term feature generation unit and a long-term feature generation unit illustrated in FIG. 3;

FIG. 5 is a detailed block diagram of a linear prediction-long-term prediction (LP-LTP) gain generation unit illustrated in FIG. 4;

FIG. 6A is a screen shot illustrating a variation feature SNR_Var of an LP-LTP gain according to a music signal and a speech signal;

FIG. 6B is a reference diagram illustrating the distribution feature of a frequency percent according to the variation feature SNR_VAR of FIG. 6A;

FIG. 6C is a reference diagram illustrating the distribution feature of cumulative frequency percent according to the variation feature SNR_VAR of FIG. 6A;

FIG. 6D is a reference diagram illustrating a long-term feature SNR_SP according to the LP-LTP gain of FIG. 6A;

FIG. 7A is a screen shot illustrating a variation feature TILT_VAR of a spectrum tilt according to a music signal and a speech signal;

FIG. 7B is a reference diagram illustrating a long-term feature TILT_SP of the spectrum tilt of FIG. 7A;

FIG. 8A is a screen shot illustrating a variation feature ZC_Var of a zero crossing rate according to a music signal and a speech signal;

FIG. 8B is a reference diagram illustrating a long-term feature ZC_SP with respect to the zero crossing rate of FIG. 8A;

FIG. 9 is a reference diagram illustrating a long-term feature SPP according to a music signal and a speech signal;

FIG. 10 is a flowchart illustrating a method to classify an audio signal according to an embodiment of the present general inventive concept; and

FIG. 11 is a block diagram of an apparatus to decode for an audio signal according to an exemplary embodiment of the present general inventive concept.

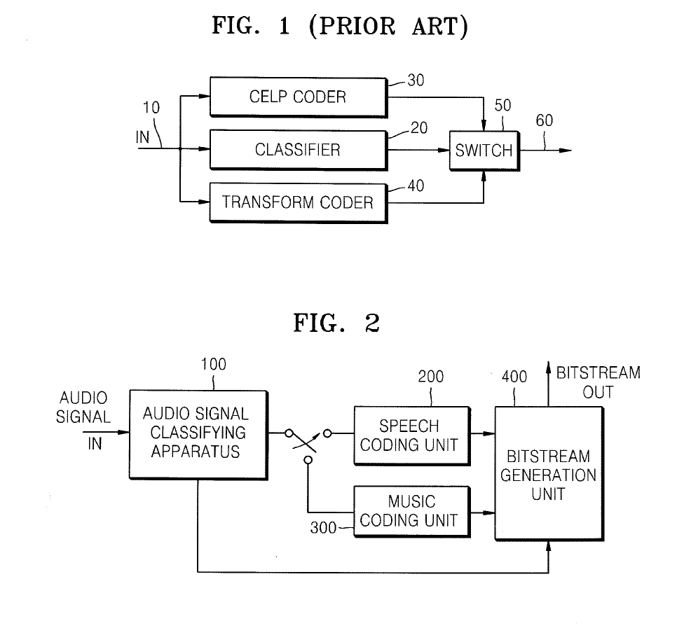

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 2A is a block diagram of an apparatus to encode for an audio signal according to an embodiment of the present general inventive concept. Referring to FIG. 2A, the apparatus to encode for an audio signal includes an audio signal classifying apparatus 100, a speech coding unit 200, a music coding unit 300, and a bitstream multiplexer 400.

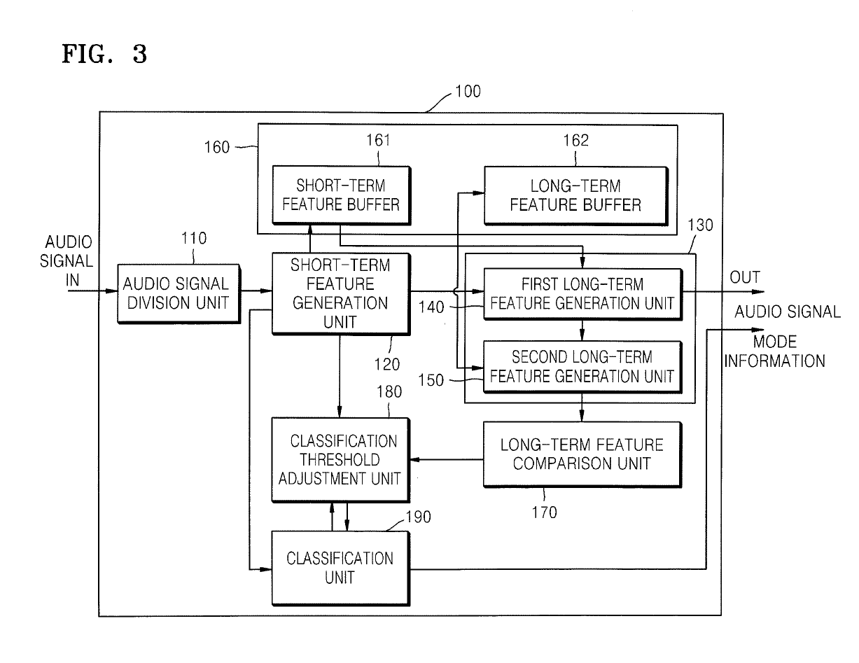

The audio signal classifying apparatus 100 divides an input audio signal into frames based on the input time of the audio signal, and determines whether each of the frames is a speech signal or a music signal. The audio signal classifying apparatus 100 transmits as additional information classification information indicating whether a current frame is a speech signal or a music signal, to the bitstream multiplexer 400. The detailed construction of the audio signal classifying apparatus 100 is illustrated in FIG. 3 and will be described later. Also, the audio signal classifying apparatus 100 may further include a time-to-frequency conversion unit (not shown) that converts an audio signal in the time domain into a signal in the frequency domain.

The speech coding unit 200 encodes an audio signal corresponding to a frame that is classified into the speech signal by the audio signal classifying apparatus 100, and transmits the encoded audio signal to the bitstream multiplexer 400.

In the current embodiment, encoding is performed by the speech coding unit 200 and the music coding unit 300, but an audio signal may be encoded by a time-domain coding unit and a frequency-domain coding unit. In this case, it is efficient to encode a speech signal by using a time-domain coding method, and encode a music signal by using a frequency-domain coding method. Code excited linear prediction (CELP) may be employed as the time-domain coding method, and transform coded excitation (TCX) and advanced audio codec (AAC) may be employed as the frequency-domain coding method.

The bitstream multiplexer 400 receives the encoded audio signal from the speech coding unit 200 or the music coding unit 300 and the classification information from the audio signal classifying apparatus 100, and generates a bitstream using the received signal and the classification information. In particular, the classification information can be used to generate a bitstream in a decoding mode in order to determine a method of efficiently reconstruct an audio signal.

FIG. 3 is a block diagram of an audio signal classifying apparatus 100 according to an exemplary embodiment of the present invention. Referring to FIG. 3, the audio signal classifying apparatus 100 includes an audio signal division unit 110, a short-term feature generation unit 120, a long-term feature generation unit 130, a buffer 160 including a short-term feature buffer 161 and a long-term feature buffer 162, a long-term feature comparison unit 170, a classification threshold adjustment unit 180, and a classification unit 190.

The audio signal division unit 110 divides an input audio signal into frames in the time domain and transmits the divided audio signal to the short-term feature generation unit 120.

The short-term feature generation unit 120 performs short-term analysis with respect to the divided audio signal to generate a short-term feature. In the current embodiment, the short-term feature is the unique feature of each frame, the use of which can determine whether the current frame is in a music mode or a speech mode and which one of time domain and the frequency domain is an efficient encoding domain for the current frame.

The short-term feature may include a linear prediction-long-term prediction (LP-LTP) gain, a spectrum tilt, a zero crossing rate, a spectrum autocorrelation, and the like.

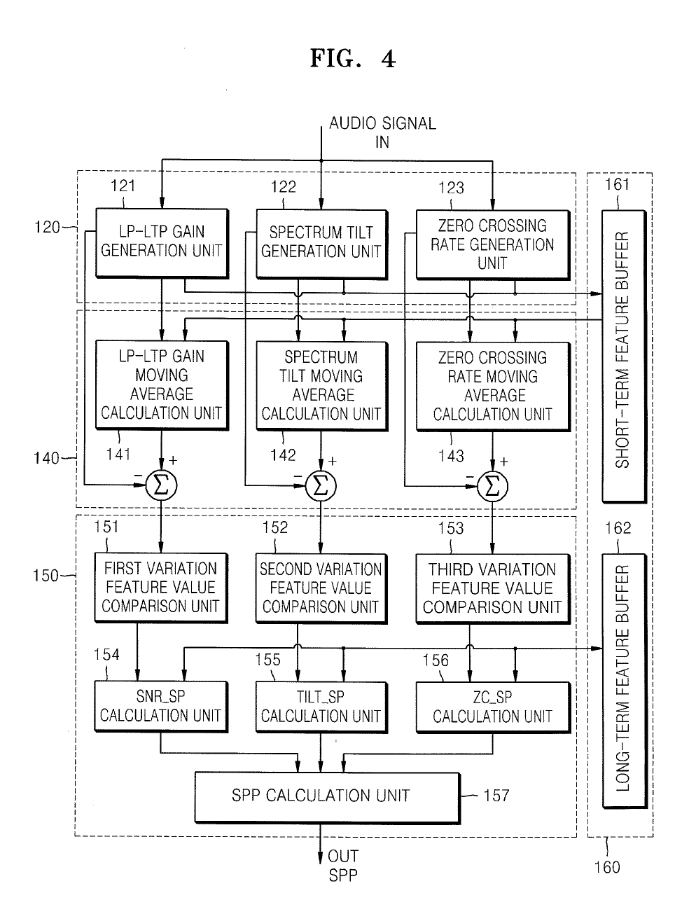

The short-term feature generation unit 120 may independently generate and output one short-term feature or a plurality of short-term features, or output the sum of a plurality of weighted short-term features as a representative short-term feature. The detailed structure of the short-term feature generation unit 120 is illustrated in FIG. 4 and will be described later.

The long-term feature generation unit 130 generates a long-term feature using the short-term feature generated by the short-term feature generation unit 120 and features that are stored in the short-term feature buffer 161 and the long-term feature buffer 162. The long-term feature generation unit 130 includes a first long-term feature generation unit 140 and a second long-term feature generation unit 150.

The first long-term feature generation unit 140 obtains information about the short-term features of 5 consecutive previous frames preceding the current frame from the short-term feature buffer 161 to calculate an average value and calculates the difference between the short-term feature of the current frame and the calculated average value, thereby generating a variation feature.

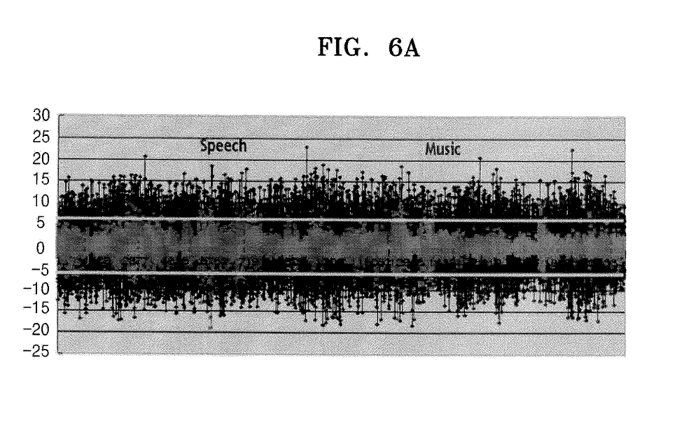

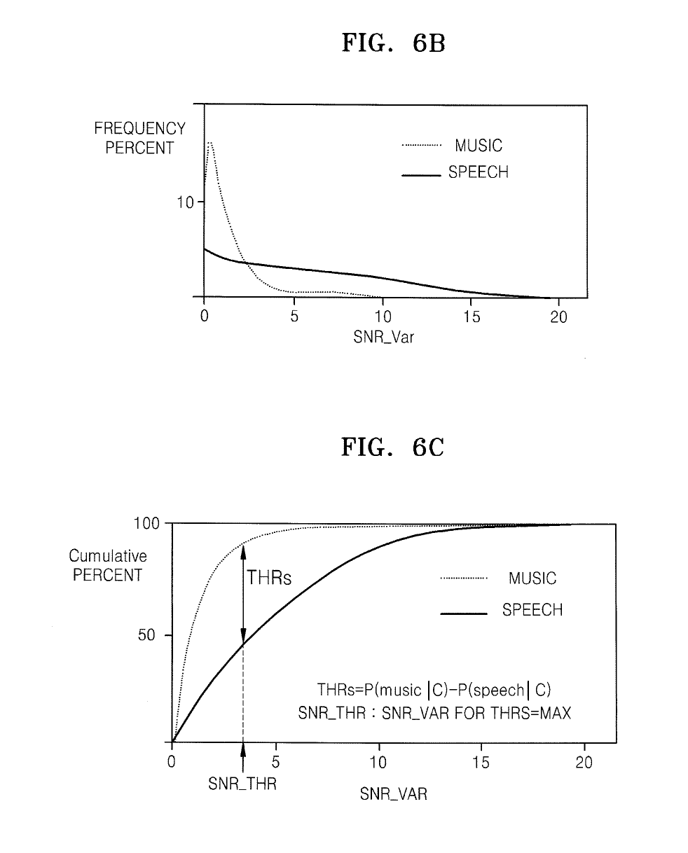

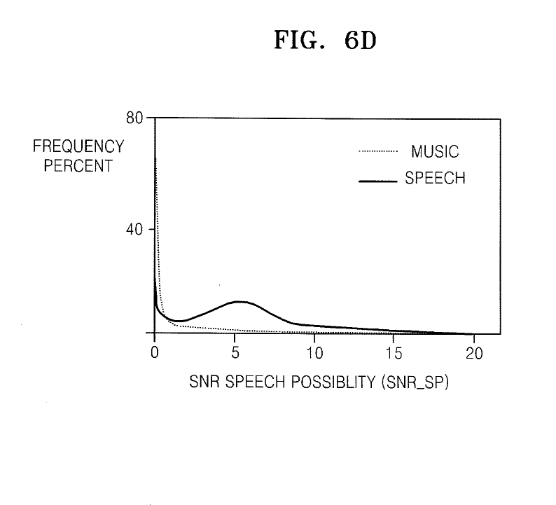

When the short-term feature is an LP-LTP gain, the average value is an average of LP-LTP gains of the previous frames preceding the current frame and the variation feature is information describing how much the LP-LTP gain of the current frame deviates from the average value corresponding to a predetermined term. As can be seen in FIG. 6B, a variation feature Signal to Noise Ratio Variation (SNR_VAR) is distributed over different areas when the audio signal is a speech signal or in a speech mode, while the variation feature SNR_VAR is concentrated over a small area when the audio signal is a music signal or in a music mode.

The second long-term feature generation unit 150 generates a long-term feature having a moving average that considers a per-frame change in the variation feature generated by the first long-term feature generation unit 140 under a predetermined constraint. Here, the predetermined constraint means a condition and a method for applying a weight to the variation feature of a previous frame preceding the current frame. The second long-term feature generation unit 150 distinguishes between a case where the variation feature of the current frame is greater than a predetermined threshold and a case where the variation feature of the current frame is less than the predetermined threshold, and applies different weights to the variation feature of the previous frame and the variation feature of the current frame, thereby generating a long-term feature. Here, the predetermined threshold is a preset value for distinguishing between a speech signal and a music signal. The generation of the long-term feature will later be described in more detail.

As mentioned above, the buffer 160 includes the short-term feature buffer 161 and the long-term feature buffer 162. The short-term feature buffer 161 stores a short-term feature generated by the short-term feature generation unit 120 for at least a predetermined period of time, and the long-term feature buffer 162 stores a long-term feature generated by the first long-term feature generation unit 140 and the second long-term feature generation unit 150 for at least a predetermined period of time.

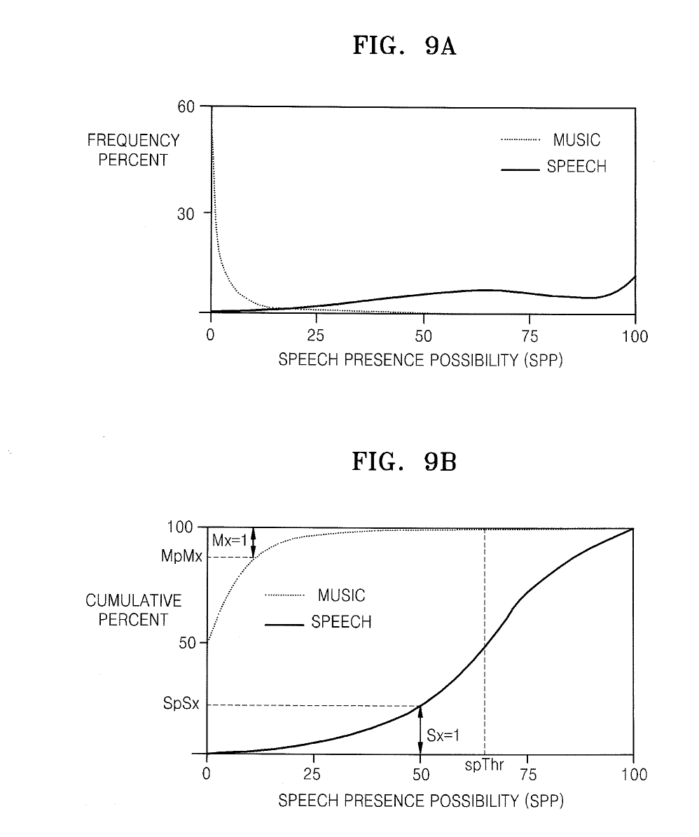

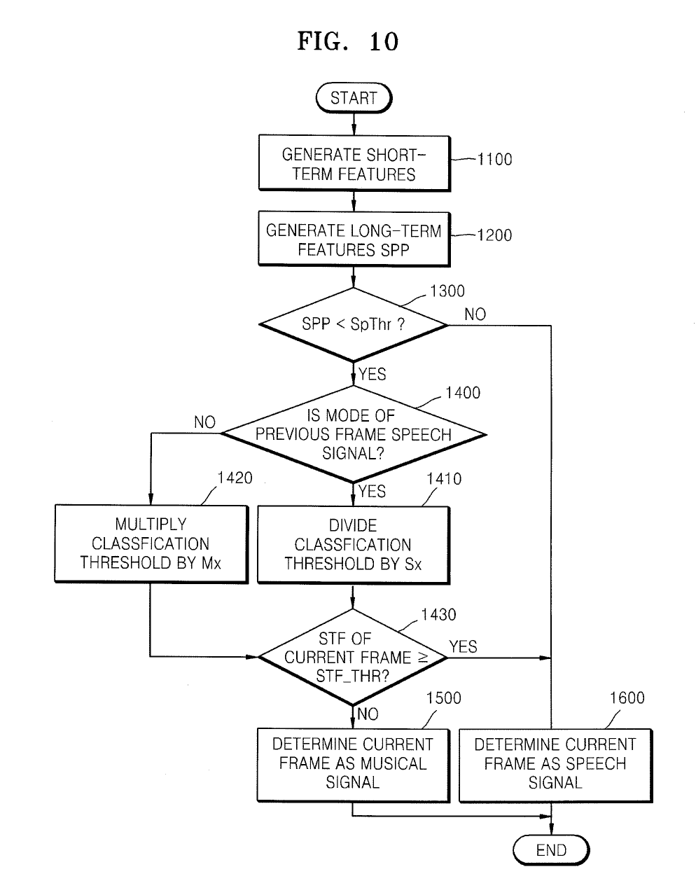

The long-term feature comparison unit 170 compares the long-term feature generated by the second long-term feature generation unit 150 with a predetermined threshold. Here, the predetermined threshold is a long-term feature for the case where there is a high possibility that a current signal is a speech signal and is previously determined by preliminary statistical analysis. When a threshold SpThr for a long-term feature is set as illustrated in FIG. 9B and the long-term feature generated by the second long-term feature generation unit 150 is greater than the threshold SpThr, the possibility that the current frame is a music signal is less than 1%. In other words, when the long-term feature is greater than the threshold, the current frame can be classified into a speech signal.

When the long-term feature is less than the threshold, the type of the current frame can be determined by a process of adjusting a classification threshold and comparison of the short-term feature with the classification threshold. The threshold may be adjusted based on the hit rate of classification and as illustrated in FIG. 9B, the hit rate of classification is lowered by setting the threshold low.

The classification threshold adjustment unit 180 adaptively adjusts the classification threshold that is referred to for classifying the current frame when the long-term feature generated by the second long-term feature generation unit 150 is less than the threshold, i.e., when it is difficult to determine the type of the current frame only with the long-term feature.

The classification threshold adjustment unit 180 receives classification information of a previous frame from the classification unit 190, and adjusts the classification threshold adaptively according to whether the previous frame is classified into the speech signal or the music signal. The classification threshold is used to determine whether the short-term feature of a frame that is to be classified, i.e., the current frame, has a property of the speech signal or the music signal. The main technical idea of the current embodiment is that the classification threshold is adjusted according to whether a previous frame preceding the current frame is classified into the speech signal or the music signal. The adjustment of the classification threshold will later be described in detail.

The classification unit 190 compares a short-term feature STF_THR of the current frame with a classification threshold STF_THR adjusted by the classification threshold adjustment unit 180 in order to determine whether the current frame is the speech signal or the music signal.

FIG. 4 is a detailed block diagram of the short-term feature generation unit 120 and the long-term feature generation unit 130 illustrated in FIG. 3. The short-term feature generation unit 120 includes an LP-LTP gain generation unit 121, a spectrum tilt generation unit 122, and a zero crossing rate (ZCR) generation unit 123. The long-term feature generation unit 130 includes an LP-LTP moving average calculation unit 141, a spectrum tilt moving average calculation unit 142, a zero crossing rate moving average calculation unit 143, a first variation feature comparison unit 151, a second variation feature comparison unit 152, a third variation feature comparison unit 153, a SNR_SP calculation unit 154, a TILT_SP calculation unit 155, and a ZC_SP calculation unit 156.

The LP-LTP gain generation unit 127 generates an LP-LTP gain of the current frame by short-term analysis with respect to each frame of the input audio signal.

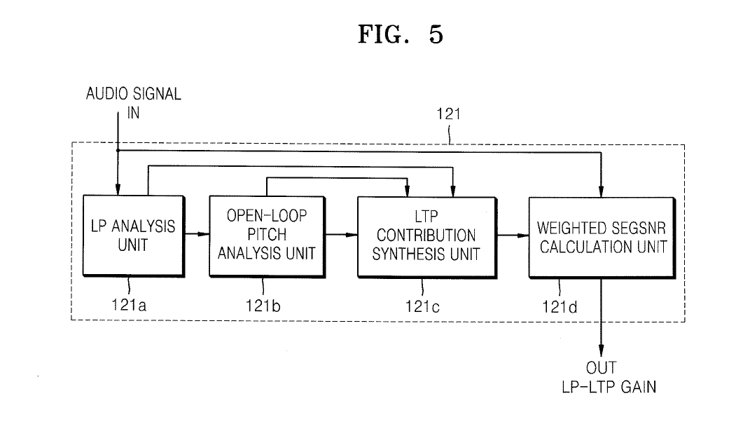

FIG. 5 is a detailed block diagram of the LP-LTP gain generation unit 121. Referring to FIG. 5, the LP-LTP gain generation unit 121 includes an LP analysis unit 121a, an open-loop pitch analysis unit 121b, an LTP contribution synthesis unit 121c, and a weighted SegSNR calculation unit 121d.

The LP analysis unit 121a calculates PrdErr, r[0] by performing linear analysis with respect to an audio signal corresponding to the current frame, and calculates an LPC gain using the calculated value as follows:

LPC gain=−10.*log 10((PrdErr/(r[0]+0.0000001)) (1),

where PrdErr is a prediction error according to Levinson-Durbin that is a process of obtaining an LP filter coefficient, and r[0] is the first reflection coefficient.

The LP analysis unit 121a calculates a linear prediction coefficient (LPC) using autocorrelation with respect to the current frame. At this time, a short-term analysis filter is specified by the LPC and a signal passing through the specified filter is transmitted to the open-loop pitch analysis unit 121b.

The open-loop pitch analysis unit 121b calculates a pitch correlation by performing long-term analysis with respect to an audio signal that is filtered by the short-term analysis filter. The open-pitch loop analysis unit 121b calculates an open-loop pitch lag for the maximum cross correlation between an audio signal corresponding to a previous frame stored in the buffer 160 and an audio signal corresponding to the current frame, and specifies a long-term analysis filter using the calculated lag. The open-loop pitch analysis unit 121b obtains a pitch using correlation between a previous audio signal and the current audio signal, which is obtained by the LP analysis unit 121a, and divides the correlation by the pitch, thereby calculating a normalized pitch correlation. The normalized pitch correlation rₓ can be calculated as follows:

$${r}_{x} = \frac{{\sum }_{i} {x}_{i} {x}_{1 - T}}{\sqrt{{\sum }_{i} {x}_{i} {x}_{i} {\sum }_{i} {x}_{i - T} {x}_{i - T}}} \qquad ( 2 )$$

where T is an estimation value of an open-loop pitch period and xᵢ is a weighted value of an input signal.

The LP-LTP synthesis unit 121c receives zero excitation as an input and performs LP-LTP synthesis.

The weighted SegSNR calculation unit 121d calculates an LP-LTP gain of a reconstructed signal received from the LP-LTP synthesis unit 121c. The LP-LTP gain, which is a short-term feature of the current frame, is transmitted to the LP_LTP moving average calculation unit 141.

The LP_LTP moving average calculation unit 141 calculates an average of LP-LTP gains of a predetermined number of previous frames preceding the current frame, which are stored in the short-term feature buffer 161.

The first variation feature comparison unit 151 receives a difference SNR_VAR between the moving average calculated by the LP_LTP moving average calculation unit 141 and the LP-LTP gain of the current frame, and compares the received difference with a predetermined threshold SNR_THR.

The SNR_SP calculation unit 154 calculates a long-term feature SNR_SP by an ‘if’ conditional statement according to the comparison result obtained by the first variation feature comparison unit 151, as follows:

if (SNR_VAR>SNR_THR)

SNR_SP=a₁*SNR_SP+(1−a₁)*SNR_VAR

else (3),

SNR_SP=D₁

where an initial value of SNR_SP is 0, a₁ is a real number between 0 and 1 and is a weight for SNR_SP and SNR_VAR, and D₁ is β₁×(SNR_THR/LT-LTP gain) in which β₁ is a constant indicating the degree of reduction.

In Equation (3), a₁ is a constant that suppresses a mode change between the speech mode and the music mode, caused by noise, and the larger a₁ allows smoother reconstruction of an audio signal. According to the ‘if’ conditional statement expressed by Equation (3), the long-term feature SNR_SP increases when SNR_VAR is greater than the threshold SNR_THR and the long-term feature SNR_SP is reduced from SNR_SP of a previous frame by a predetermined value when SNR_VAR is less than the threshold SNR_THR.

The SNR_SP calculation unit 154 calculates the long-term feature SNR_SP by executing the ‘if’ conditional statement expressed by Equation (3) for each frame of the input audio signal. SNR_VAR is also a kind of long-term feature, but is transformed into SNR_SP having a distribution illustrated in FIG. 6D.

FIGS. 6A through 6D are reference diagrams for explaining distribution features of SNR_VAR, SNR_THR, and SNR_SP according to the current exemplary embodiment.

FIG. 6A is a screen shot illustrating a variation feature SNR_VAR of an LP-LTP gain according to a music signal and a speech signal. It can be seen from FIG. 6A that SNR_VAR generated by the LP-LTP gain generation unit 121 has different distributions according to whether an input signal is a speech signal or a music signal.

FIG. 6B is a reference diagram illustrating the statistical distribution feature of a frequency percent according to the variation feature SNR_VAR of the LP-LTP gain. In FIG. 6B, the vertical axis indicates a frequency percent, i.e., (frequency of SNR_VAR/total frequency)×100%. An uttered speech signal is generally composed of voiced sound, unvoiced sound, and silence. The voiced sound has a large LP-LTP gain, and the unvoiced sound and silence have small LP-LTP gains. Thus, most speech signals having a switch between voiced sound and unvoiced sound have a large SNR_VAR within a predetermined interval. However, music signals are continuous or have a small LP-LTP gain change and thus have a smaller SNR_VAR than the speech signals.

FIG. 6C is a reference diagram illustrating the statistical distribution feature of a cumulative frequency percent according to the variation feature SNR_VAR of an LP-LTP gain. Since music signals are mostly distributed in an area having small SNR_VAR, the possibility of the presence of the music signal is very low when SNR_VAR is greater than a predetermined threshold as can be seen in the cumulative curve. A speech signal has a gentler cumulative curve than a music signal. In this case, THR may be defined as P(music|S)−P(speech|S) and SNR_VAR for the maximum THR may be defined as (SNR_THR). Here, P(music|S) is the probability that the current audio signal is a music signal under a condition S, and P(speech|S) is a probability that the current audio signal is a speech signal under the condition S. In the current embodiment, SNR_THR is employed as a criterion for executing a conditional statement for obtaining SNR_SP, thereby improving the accuracy of distinguishment between a speech signal and a music signal.

FIG. 6D is a reference diagram illustrating a long-term feature SNR_SP according to an LP-LTP gain. The SNR_SP calculation unit 154 generates a new long-term feature SNR_SP for SNR_VAR having a distribution illustrated in FIG. 6A by executing the conditional statement. It can also be seen from FIG. 6D that SNR_SP values for a speech signal and a music signal, which are obtained by executing the conditional statement according to the threshold SNR_THR, are definitely distinguished from each other.

The spectrum tilt generation unit 122 generates a spectrum tilt of the current frame using short-term analysis for each frame of an input audio signal. The spectrum tilt is a ratio of energy according to a low-band spectrum to energy according to a high-band spectrum and is calculated as follows:

eₜᵢₗₜ=Eₗ/Eₕ (4),

where Eₕ is an average energy in a high band and Eₗ is an average energy in a low band. The spectrum tilt moving average calculation unit 142 calculates an average of spectrum tilts of a predetermined number of frames preceding the current frame, which are stored in the short-term feature buffer 161, or calculates an average of spectrum tilts including the spectrum tilt of the current frame generated by the spectrum tilt generation unit 122.

The second variation feature comparison unit 152 receives a difference Tilt_VAR between the average generated by the spectrum tilt moving average calculation unit 142 and the spectrum tilt of the current frame generated by the spectrum tilt generation unit 122 and compares the received difference with a predetermined threshold TILT_THR.

The TILT_SP calculation unit 155 calculates a tilt speech possibility TILT_SP that is a long-term feature by executing an ‘if’ conditional statement expressed by Equation (5) according to the comparison result obtained by the spectrum tilt variation feature comparison unit 152, as follows:

if (TILT_VAR>TILT_THR)

TILT_SP=a₂*TILT_SP+(1−a₂)*TILT_VAR

else (5),

TILT_SP=D₂

where an initial value of TILT_SP is 0, a₂ is a real number between 0 and 1 and is a weight for TILT_SP and TILT_VAR, and D₂ is β₂×(TILT_THR/SPECTRUM TILT) in which β₂ is a constant indicating the degree of reduction. A detailed description that is common to TILT_SP and SNR_SP will not be given.

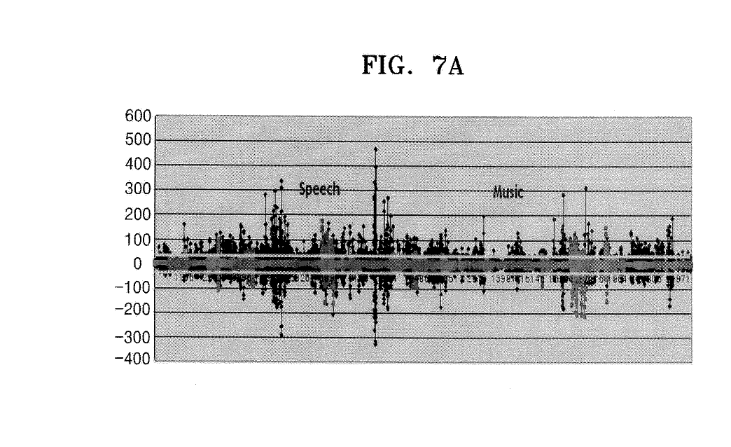

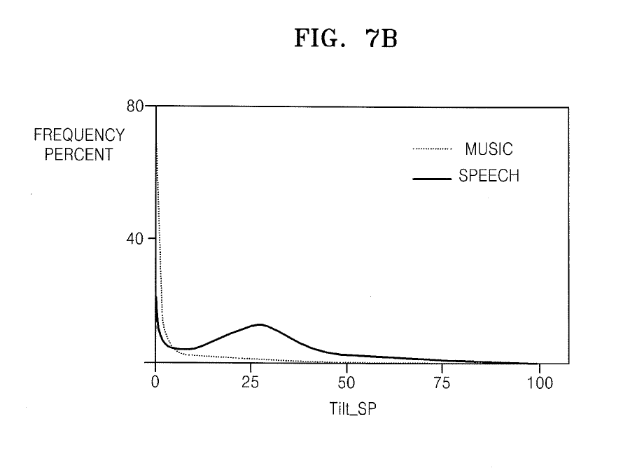

FIG. 7A is a screen shot illustrating a variation feature TILT_VAR of a spectrum tilt gain according to a music signal and a speech signal. The variation feature TILT_VAR generated by the spectrum tilt generation unit 122 differs according to whether an input signal is a speech signal or a music signal.

FIG. 7B is a reference diagram illustrating a long-term feature TILT_SP of a spectrum tilt. The TILT_SP calculation unit 155 generates a new long-term feature TILT_SP by executing the conditional statement with respect to TILT_VAR having a distribution illustrated in FIG. 7B. It can also be seen from FIG. 7B that TILT_SP values for a speech signal and a music signal, which are obtained by executing the conditional statement according to the threshold TILT_THR, are definitely distinguished from each other.

The ZCR generation unit 123 generates a zero crossing rate of the current frame by performing short-term analysis for each frame of the input audio signal. The zero crossing rate means the frequency of occurrence of a signal change in input samples with respect to the current frame and is calculated according to a conditional statement using Equation (6) as follows:

if (S(n)·S(n−1)<0) ZCR=ZCR+1 (6),

where S(n) is a variable for determining whether an audio signal corresponding to the current frame n is a positive value or a negative value, and an initial value of ZCR is 0.

The ZCR average calculation unit 143 calculates an average of zero crossing rates of a predetermined number of previous frames preceding the current frame, which are stored in the short-term feature buffer 161, or calculates an average of zero crossing rates including the zero crossing rate of the current frame, which is generated by the ZCR generation unit 123.

The third variation feature comparison unit 153 receives a difference ZC_VAR between the average generated by the ZCR average calculation unit 143 and the zero crossing rate of the current frame generated by the ZCR generation unit 123, and compares the received difference with a predetermined threshold ZC_THR.

The ZC_SP calculation unit 156 calculates ZC_SP that is a long-term feature by executing an ‘if’ conditional statement expressed by Equation (7) according to the comparison result obtained by the zero crossing rate variation feature comparison unit 153, as follows:

if (ZC_VAR>ZC_THR)

ZC_SP=a₃*ZC_SP+(1−a₃)*ZC_VAR

else (7),

ZC_SP=D₃

where an initial value of ZC_SP is 0, a₃ is a real number between 0 and 1 and is a weight for ZC_SP and ZC_VAR, D₃ is β₃×(ZC_THR/zero-crossing rate) in which β₃ is a constant indicating the degree of reduction, and zero-crossing rate is a zero crossing rate of the current frame. A detailed description that is common to ZC_SP and SNR_SP will not be given.

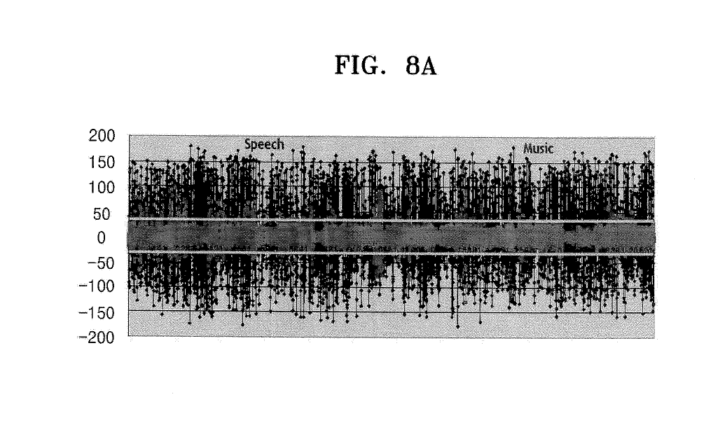

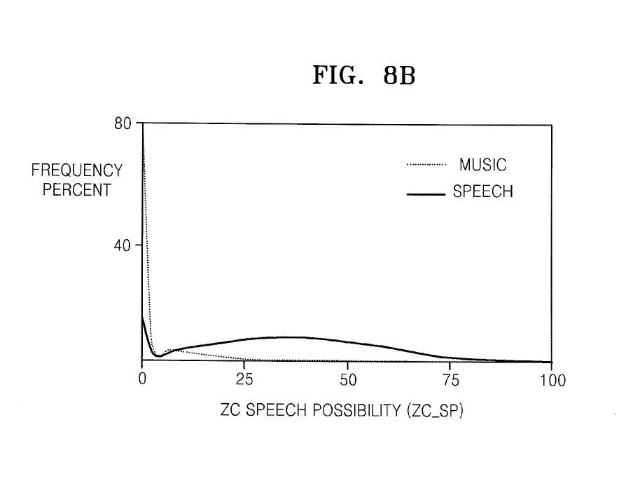

FIG. 8A is a screen shot illustrating a variation feature ZC_VAR of a zero crossing rate according to a music signal and a speech signal. ZC_VAR generated by the ZCR generation unit 123 differs according to whether an input signal is a speech signal or a music signal.

FIG. 8B is a reference diagram illustrating a long-term feature ZC_SP of a zero crossing rate. The ZC_SP calculation unit 155 generates a new long-term feature value ZC_SP by executing the conditional statement with respect to ZC_VAR having a distribution as illustrated in FIG. 8B. It can also be seen from FIG. 8B that ZC_SP values for a speech signal and a music signal, which are obtained by executing the conditional statement according to the threshold ZC_THR, are definitely distinguished from each other.

The SPP generation unit 157 generates a speech presence possibility (SPP) using a long-term feature calculated by each of the SNR_SP calculation unit 154, the TILT_SP calculation unit 155, and the ZC_SP calculation unit 156, as follows:

SPP=SNR_W·SNR_SP+TILT_W·TILT_SP+ZC_W·ZC_SP (8),

where SNR_W is a weight for SNR_SP, TILT_W is a weight for TILT_SP, and ZC_W is a weight for ZC_SP.

Referring to FIGS. 6C, 7B, and 8B, SNR_W is calculated by multiplying P(music|S)−P(speech|S)=0.46(46%) according to SNR_THR by a predetermined normalization factor. Here, although there is no special restriction on the normalization factor, SNR_SP(=7.5) for a 90% SNR_SP cumulative probability of a speech signal may be set to the normalization factor. Similarly, TILT_W is calculated using P(music|T)−P(speech|T)=0.35(35%) according to TILT_THR and a normalization factor for TILT_SP. The normalization factor for TILT_SP is TILT_SP(=45) for a 90% TILT_SP cumulative probability of a speech signal. ZC_W can also be calculated using P(music|Z)−P(speech|Z)=0.32(32%) according to ZC_THR and a normalization factor(=75) for ZC_SP.

FIG. 9A is a reference diagram illustrating the distribution feature of an SPP generated by the SPP generation unit 157. The short-term features generated by the LP-LTP gain generation unit 121, the spectrum tilt generation unit 122, and the ZCR generation unit 123 are transformed into a new long-term feature SPP by the above-described process, and a speech signal and a music signal can be more definitely distinguished from each other based on the long-term feature SPP.

FIG. 9B is a reference diagram illustrating a cumulative long-term feature according to the long-term feature SPP of FIG. 9A. A long-term feature threshold SpThr may be set to an SPP for a 99% cumulative distribution of a music signal. When the SPP of the current frame is greater than the threshold SpThr, an audio signal corresponding to the current frame may be determined as a speech signal. However, when the SPP of the current frame is less than the threshold SpThr, a classification threshold is adjusted based on whether a previous frame is classified into a speech signal or a music signal, and the adjusted classification threshold is compared with the short-term feature of the current frame, thereby classifying the current frame into the speech signal or the music signal.

As described above, the present invention discloses a method of distinguishing between a speech signal and a music signal included in an audio signal. Voice activity detection (VAD) has been widely used to distinguish between a desired signal and the other signal that are included in an audio signal. However, VAD has been designed to mainly process speech signals, and is thus unavailable under an environment in which speech, music, and noise are mixed. According to the present invention, it is possible to classify audio signals into speech signals and music signals, and the present invention can be generally applied to an encoding apparatus that encodes an audio signal according to whether it is a music signal or a speech signal, and Universal Codec and the like.

FIG. 10 is a flowchart illustrating a method to classify an audio signal according to an exemplary embodiment of the present general inventive concept.

Referring to FIGS. 3 and 10, in operation 1100, the short-term feature generation unit 120 divides an input audio signal into frames and calculates an LP-LTP gain, a spectrum tilt, and a zero crossing rate by performing short-term analysis with respect to each of the frames. Although there is no special restriction on the type of short-term feature, a hit rate of 90% or higher can be achieved when the audio signal is classified in units of frames using three types of short-term features. The calculation of the short-term features has already been described above and thus will be omitted here.

In operation 1200, the long-term feature generation unit 130 calculates long-term features SNR_SP, TILT_SP, and ZC_SP by performing long-term analysis with respect to the short-term features generated by the short-term feature generation unit 120, and applies weights to the long-term features, thereby calculating an SPP.

In operation 1100 and operation 1200, short-term features and long-term features of the current frame are calculated. Methods of calculating short-term features and long-term features of the current frame have been described above. Although not illustrated in FIG. 10, before performing operations 1100 and 1200, it is necessary to obtain information regarding the distributions of shot-term features and long-term features from speech data and music data, and make the obtained information a database.

In operation 1300, the long-term feature comparison unit 170 compares SPP of the current frame calculated in operation 1200 with a preset long-term feature threshold SpThr. When SPP is greater than SpThr, the current frame is determined as a speech signal. When SPP is less than SpThr, a classification threshold is adjusted and compared with a short-term feature, thereby determining the type of the current frame.

In operation 1400, the classification threshold adjustment unit 180 receives classification information about a previous frame from the long-term feature comparison unit 170 or the long-term feature buffer 162, and determines whether the previous frame is classified into a speech signal or a music signal according to the received classification information.

In operation 1410, the classification threshold adjustment unit 180 outputs a value obtained by dividing a classification threshold STF_THR for determining a short-term feature of the current frame by a value Sx when the previous frame is classified into the speech signal. Sx is a value having an attribute of a cumulative probability of a speech signal and is intended to increase or reduce the classification threshold. Referring to FIG. 9A, SPP for an Sx of 1 is selected, and a cumulative probability with respect to each SPP is divided by a cumulative probability with respect to SpSx, thereby calculating normalized Sx. When SPP of the current frame is between SpSx and SpThr, the mode determination threshold STF_THR is reduced in operation 1410 and the possibility that the current frame is determined as the speech signal is increased.

In operation 1420, the classification threshold adjustment unit 180 outputs a product of the classification threshold STF_THR for determining the short-term feature of the current frame and a value Mx when the previous frame is determined as the music signal. Mx is a value having an attribute of a cumulative probability of a music signal and is intended to increase or reduce the classification threshold. As illustrated in FIG. 9B, a music presence possibility (MPP) for an Mx of 1 may be set as MpMx and a probability with respect to each MPP is divided by a probability with respect to MpMx, thereby calculating normalized Mx. When Mx is greater than MpMx, the classification threshold STF_THR is increased and the possibility that the current frame is determined as the music signal is also increased.

In operation 1430, the classification threshold adjustment unit 180 compares the short-term feature of the current frame with the classification threshold STF_THR that is adaptively adjusted in operation 1410 or operation 1420, and outputs the comparison result.

In operation 1500, when it is determined in operation 1430 that the short-term feature of the current frame is less than the adjusted classification threshold STF_THR, the classification unit 190 determines the current frame as the music signal, and outputs the determination result as classification information.

In operation 1600, when it is determined in operation 1430 that the short-term feature of the current frame is greater than the adjusted classification threshold STF_THR, the classification unit 190 determines the current frame as the speech signal, and outputs the determination result as classification information.

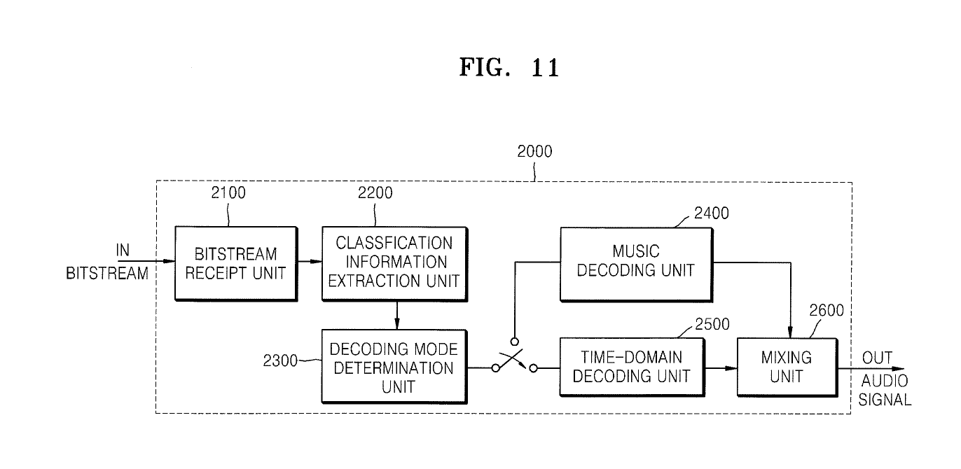

FIG. 11 is a block diagram of a decoding apparatus 2000 for an audio signal according to an exemplary embodiment of the present general inventive concept.

Referring to FIG. 11, a bitstream receipt unit 2100 receives a bitstream including classification information for each frame of an audio signal. A classification information extraction unit 2200 extracts the classification information from the received bitstream. A decoding mode determination unit 2300 determines a decoding mode for the audio signal according to the extracted classification information, and transmits the bitstream to a music decoding unit 2400 or a speech decoding unit 2500.

The music decoding unit 2400 decodes the received bitstream in the frequency domain and the speech decoding unit 2500 decodes the received bitstream in the time domain. A mixing unit 2600 mixes the decoded signals in order to reconstruct the audio signal.

The present invention can also be embodied as computer-readable code on a computer-readable recording medium. The computer-readable recording medium is any data storage device that can store data which can be thereafter read by a computer system.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as carrier waves, as well as through the Internet, for example. Thus, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

While aspects of the present invention has been particularly shown and described with reference to differing embodiments thereof, it should be understood that these exemplary embodiments should be considered in a descriptive sense only and not for purposes of limitation. Any narrowing or broadening of functionality or capability of an aspect in one embodiment should not considered as a respective broadening or narrowing of similar features in a different embodiment, i.e., descriptions of features or aspects within each embodiment should typically be considered as available for other similar features or aspects in the remaining embodiments.

Thus, although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of classifying an audio signal, comprising:
(a) analyzing the audio signal in units of frames, and generating a short-term feature and a long-term feature from the result of analyzing;
(b) adaptively adjusting a classification threshold for a current frame that is to be classified, according to the generated long-term feature; and
(c) classifying the current frame using the adjusted classification threshold.

2. The method of claim 1, further comprising comparing the long-term feature of the current frame with a predetermined threshold,
wherein (b) comprises adaptively adjusting the classification threshold according to the comparison result.

3. The method of claim 1, wherein the generation of the long-term feature comprises generating the long-term feature using a difference between an average of short-term features of a predetermined number of previous frames preceding the current frame and the short-term feature of the current frame.

4. The method of claim 1, further comprising comparing the long-term feature of the current frame with a predetermined threshold,
wherein (b) comprises adaptively adjusting the classification threshold according to the comparison result and the result of classifying a previous frame preceding the current frame.

5. The method of claim 4, wherein (b) comprises adjusting the classification threshold in such a way as to increase a possibility that the current frame and the previous frame are classified into the same type, when the comparison result reveals that it is difficult to classify the current frame using only the long-term feature of the current frame.

6. The method of claim 1, wherein (c) comprises dividing the audio signal into frames, and classifying each of the frames into a speech signal or a music signal.

7. The method of claim 1, wherein during (c), the current frame is classified by comparing the short-term feature of the current frame with the adjusted classification threshold.

8. The method of claim 3, wherein the generation of the long-term feature comprises:
when the difference for the current frame is greater than a predetermined threshold, applying positive weights to the difference for the current frame and a difference for a previous frame preceding the current frame between an average of short-term features of a predetermined number of previous frames preceding the previous frame and the short-term feature of the previous frame, and summing the weight-applied differences so as to generate the long-term feature, and
when the difference for the current frame is less than the predetermined threshold, applying a negative weight to the difference for the current frame and a positive weight to the difference for the previous frame, and summing the weight-applied differences or reducing a long-term feature of the previous frame so as to generate the long-term feature.

9. The method of claim 8, wherein during (c), the audio signal is divided into frames units and each of the frames is classified into a speech signal or a music signal, and
the predetermined threshold used to generate the long-term feature is a difference for a maximum difference between a possibility of the presence of the audio signal and a possibility of the presence of the music signal.

10. The method of claim 1, wherein the long-term feature is at least one selected from a group consisting of a linear prediction-long-term prediction gain, a spectrum tilt, and a zero crossing rate.

11. A computer-readable recording medium having recorded thereon a computer program for implementing the method of claim 1.

12. A method of encoding an audio signal, comprising:
(a) dividing an audio signal in units of frames and classifying the frames according to the method of claim 1;
(b) encoding the audio signal according to the result of classification; and
(c) generating a bitstream by performing bitstream processing on the encoded signal.

13. The method of claim 12, wherein the generated bitstream includes classification information for the audio signal.

14. The method of claim 12, wherein the encoding in (b) comprises performing encoding in the time domain when the frames are classified into speech signals, and performing encoding in the frequency signal when the frames are classified into music signals.

15. An apparatus for classifying an audio signal, comprising:
a short-term feature generation unit to analyze the audio signal in units of frames and generating a short-term feature;
a long-term feature generation unit to generate a long-term feature using the short-term feature;
a classification threshold adjustment unit to adaptively adjust a classification threshold for a current frame that is to be classified, by using the generated long-term feature; and
a classification unit to classify the current frame using the adjusted classification threshold.

16. The apparatus of claim 15, further comprising a long-term feature comparison unit to compare the long-term feature of the current frame with a predetermined threshold,
wherein the classification unit classifies the current frame, based on a long-term feature of a previous frame preceding the current frame and the result of comparison received from the long-term feature comparison result.

17. The apparatus of claim 15, wherein the long-term feature generation unit comprises:
a first long-term feature generation unit to generate a first long-term feature using short-term features of a predetermined number of previous frames preceding the current frame; and
a second long-term feature generation unit to generate a second long-term feature by using the first long-term feature generated by the first long-term feature generation unit, and a first long-term feature of the previous frames,
wherein the classification threshold adjustment unit adaptively adjusts the classification threshold for the current frame using the second long-term feature generated by the second long-term feature generation unit.

18. The apparatus of claim 15, wherein the short-term feature generation unit comprises at least one selected from a group consisting of a linear prediction-long-term prediction gain generation unit, a spectrum tilt generation unit, and a zero crossing rate generation unit.

19. An apparatus for encoding an audio signal, comprising:
a short-term feature generation unit to analyze an audio signal in units of frames and generating a short-term feature;
a long-term feature generation unit to generate a long-term feature using the short-term feature;
a classification threshold adjustment unit to adaptively adjust a classification threshold for a current frame that is to be classified, using the generated long-term feature;
a classification unit to classify the current frame using the adaptively adjusted classification threshold;
an encoding unit to perform the classified audio signal in units of frames; and
a multiplexer to perform bitstream processing on the encoded signal so as to generate a bitstream.

20. A method of decoding an audio signal, comprising:
receiving a bitstream including classification information regarding each of frames of an audio signal, where the classification information is adaptively determined using a long-term feature of the audio signal;
determining a decoding mode for the audio signal based on the classification information; and
decoding the received bitstream according to the determined decoding mode.

21. An apparatus for decoding an audio signal, comprising:
a receipt unit to receive a bitstream including classification information for each of frames of an audio signal, where the classification information is adaptively determined using a long-term feature of the audio signal;
a decoding mode determination unit to determine a decoding mode for the received bitstream according to the classification information; and
a decoding unit to decode the received bitstream according to the determined decoding mode.
